(19) United States
(12) Patent Application Publication
(10) Pub. No.: US 2009/0255815 A1
(43) Pub. Date: Oct. 15, 2009

(54) Capacitive Deionization Using Hybrid Polar Electrodes

(76) Inventors: Lih-Ren SHIUE, Cyonglin Township (TW); Hou-Bai LEE, Taipei City (TW)

Correspondence Address: SINORICA, LLC, 2275 Research Blvd., Suite 500, ROCKVILLE, MD, 20850, US

(21) Appl. No.: 12/394,101

(22) Filed: Feb. 27, 2009

(30) Foreign Application Priority Data
Apr. 10, 2008 (TW) 097112950

(51) Int. Cl. B01D 35/06; H01G 4/005

(52) U.S. Cl. 204/665; 361/301.1

(57) ABSTRACT

Capacitive deionization (CDI) is a non-membrane and chemical-free technique for water purification, used-water recycling, and seawater desalination. Ionic contaminants in the waters are retained by a static electric field built within the critical component of CDI, which is known as flow through capacitor (FTC). Apparently, parameters enhancing the field strength of FTC and electrode efficiency are the keys to the performance of CDI. The FTC of the present invention is formed by a plurality of monopolar and a plurality of bipolar electrodes, and a plural number of perforated holes are disposed on the FTC electrodes in a pattern that allows certain water flow rate and residence time to yield the highest efficiency of electrode utilization.

### BACKGROUND OF THE INVENTION

1. Field of the Invention

This invention relates to the cell structure of a flow through capacitor (FTC) for water treatments by surface adsorption of ions. More specifically, the invention relates to the reduction of total dissolved solids (TDS) of water via a capacitor structure consisting of a plurality of monopolar electrodes and a plurality of bipolar electrodes, with the structure of which ions in waters are adsorbed as water flows through the static electric field built within the charged electrodes.

2. Background of the Related Art

Seawater is the most abundant surface water on earth. Seawater is also the water resource that is the most difficult to be purified to meet the standard of drinking water since it contains a very high concentration of salt and various contaminants disposed from lands or vessels sailing on the water. In commercial scale, reverse osmosis (RO) and distillation, particularly, multi-stage flash (MSF) evaporation, are the two most widely employed techniques for the desalination of seawater. RO has the advantages of technical maturity, high popularity and cost affordability. But RO has the disadvantages of low water-recovery rate, low chemical (for example, surfactant) resistance and low working-temperature range. MSF and other distillation processes have the advantages of indiscrimination to the composition of feedwater in terms of energy required to produce a volume of pure water and water product with high purity. Among the disadvantages of all thermal processes are high capital cost and high energy consumption. The electricity used for MSF recirculation pumps alone exceeds the overall operation energy cost for SWRO (seawater RO). Unfortunately, both RO and MSF also generate secondary pollution as they demand chemicals for regenerating their critical components, namely, porous membrane of RO and condenser (and boiler) of MSF.

As far as energy consumption and secondary pollution are concerned, capacitive deionization (CDI) is likely a better desalination technique than RO and MSF. Similar to MSF, CDI is also indiscriminate to the composition of feedwater. This means that CDI and MSF do not need heavy pretreatments on the feedwater that are absolutely necessary in RO operation, otherwise, the RO membranes will be ruined. Investment of chemicals and energy is required for the pre-treatment in RO, and secondary pollution occurs consequently. CDI uses a low DC voltage to adsorb ions from water passing through its critical component, a flow through capacitor (FTC). The adsorption of ions on FTC is same as the charging of capacitor, which is a rapid process consuming very little amount of energy. On producing a water product of same volume and same quality, CDI needs one third of energy of that needed for SWRO. Henceforth, CDI is the least energy expender among the three desalination techniques. Moreover, the regeneration of the saturated FTC modules is a simple discharging process of capacitor with electricity released for direct retrieval as well as valuable ions in their original states for extraction. Therefore, CDI is a water-treatment technique full of added values in addition to only producing freshwater.

CDI has been known for more than three decades. For example, it was disclosed in the U.S. Pat. Nos. 3,515,664 and 3,658,674. In the past twenty years, CDI had been actively promoted with a carbon aerogel used as the ion-adsorbing medium in a cell of plate-and-frame assembly as the principal design of FTC. Just to name a few, the prior arts were revealed in the U.S. Pat. Nos. 5,192,432, 5,425,858, 6,096,179, 6,309,532 and 6,569,298. There are other adsorbents employed for FTC, for example, metal oxide catalyst in U.S. Pat. No. 4,072,596, graphite in U.S. Pat. No. 6,410,128, and activated carbon in U.S. Pat. No. 6,462,935. Among the ion-adsorbing media, activated carbon is the best choice for FTC due to the carbon can offer a large surface area at low cost.

As equally important as the adsorbing material, the liquid flow path and flow pattern in the FTC cell are two other factors determining the performance of CDI operation. A serpentine flow pattern with electrode-gap of 0.05 cm is provided in the plate-and-frame cells of prior art. The long travel length and the small gap are unfavorable to the liquid flow through the FTC cells. Not only a pressure drop is experienced during the desalting stage of CDI operation, but cross contamination is inevitable at the reset of the FTC cells. In addition to the foregoing problems, jelly-roll FTC prepared by concentric winding, as seen in the U.S. Pat. Nos. 5,192,432 and 6,462,935, are further troubled with the uniform distribution of water into the cylindrical flow channels of FTC. It is the combination of low flow rate, low efficiency of electrode utilization, as well as time- and water-consuming regeneration of FTC cells that prevent CDI from becoming a viable technique for commercial water treatment.

In all FTC cells cited in the previous paragraph, only monopolar electrodes are used to construct the cells. In other words, every electrode in a FTC assembly is connected to a DC power source. Thus, every electrode carries only one polarity, positive or negative, and that is the reason why it is called monopolar electrode. For the plate-and-frame construction, there are more than 100 pairs of positive and negative plate electrodes, or more than 100 cells, connected in series to constitute the FTC module. If one cell needs a working voltage of 2V, the entire stack will require an operation voltage of more than 200V that poses safety hazard and complicate electrical connections. Regardless of the module size, there is only one cell in the jelly-roll FTC since it consists of just a pair of positive and negative electrodes. Henceforth, the overall operation voltage of the jelly-roll FTC cells can be as low as 2V, whereas the total operation current is linearly proportional to the effective electrode area.

Following the conventional theory of capacitor, the prior art focuses on minimizing the electrode gap to establish an electrostatic field as strong as possible for removing as much as ions in a single cycle. Nevertheless, a strong electrostatic field also requires an application of sufficient power than just the narrow electrode gap alone. For attaining an effective and strong field, the current invention presents a FTC module comprising of both monopolar and bipolar electrodes in a hybrid configuration to reach an optimally balanced state of working voltage and working current. In the process of desalination, while a constant voltage is applied to the FTC cells from a power supply, the actual working current is determined by the composition of feedwater and kinetics of ion adsorption. By setting a constant current value on the power supply, the charging rate is restricted and the strength of electric field is diminished as well. Therefore, the invention utilizes supercapacitor as the “un-limited” current provider to enhance the electric field built by the applied voltage and the structure of FTC cells. Moreover, the invention offers a unique flow pattern for the FTC cells to enhance the yield of the CDI technique and to push CDI technique towards viable commercial applications.

### SUMMARY OF THE INVENTION

As described above, one objective of the present invention is to disclose a FTC constituted by a plurality of stacked electrodes to form a FTC module for desalinating water with ion adsorption.

Another objective of the present invention is to disclose a FTC module that is able to remove the most ions in one single process with a proper power source supplied.

Still another objective of the present invention is to disclose a FTC module in which the fluid kinetics of water flow is optimized with different perforated hole positions arranged on each stacked electrode.

Yet another objective of the present invention is to dispose at least a supercapacitor in FTC module to reduce energy cost and shorten the circulation time of CDI operation.

According to the aforementioned objectives, the present invention provides a FTC module, comprising: an electrode plate stack structure, composed of a plurality of first electrode plates and a plurality of second electrode plates disposed at intervals, wherein each of the first electrode plates is disposed with a first pattern formed by a plurality of perforated holes and at the edge of each of the first electrode plates is disposed with an O-ring, and each of the second electrode plates is disposed with a second pattern formed by a plurality of perforated holes and at the edge of each of the second electrode plates is disposed with an O-ring; a lock-fastening device, disposed on the top end and bottom end of the electrode plate stack structure for lock-fastening the electrode plate stack structure; wherein a topmost electrode plate and a bottommost electrode plate of the electrode plate stack structure are electrically connected to an electrode of first polarity, and a middle electrode plate of the stack structure is electrically connected to an electrode of second polarity, the first polarity and the second polarity being opposite polarities.

The present invention then provides a water treatment apparatus composed of a FTC module and a DC potential source, top end of the FTC module being connected to a water inlet and bottom end of the FTC module being connected to a water outlet, wherein the characteristics of FTC module comprise: an electrode plate stack structure, composed of a plurality of first electrode plates and a plurality of second electrode plates disposed at intervals, wherein each of the first electrode plates is disposed with a first pattern formed by a plurality of perforated holes and at the edge of each of the first electrode plates is disposed with an O-ring, and each of the second electrode plates is disposed with a second pattern formed by a plurality of perforated holes and at the edge of each of the second electrode plates is disposed with an O-ring; a lock-fastening device, disposed on the top end and bottom end of the electrode plate stack structure for lock-fastening the electrode plate stack structure; wherein a topmost electrode plate and a bottommost electrode plate of the electrode plate stack structure are electrically connected to an electrode of first polarity, and a middle electrode plate of the stack structure is electrically connected to an electrode of second polarity, the first polarity and the second polarity being opposite polarities.

The present invention further provides a water treatment apparatus composed of a FTC module, a plurality of supercapacitors, a DC potential source, and a control device, the FTC module and the supercapacitors being in parallel connection, top end of the FTC module being connected to a water inlet and bottom end of the FTC module being connected to a water outlet, and the control device and the plurality of supercapacitors being connected for controlling at least two supercapacitors to perform CD swing, wherein the characteristic of water treatment apparatus is in that the FTC module comprises: an electrode plate stack structure, composed of a plurality of first electrode plates and a plurality of second electrode plates disposed at intervals, wherein each of the first electrode plates is disposed with a first pattern formed by a plurality of perforated holes and at the edge of each of the first electrode plates is disposed with an O-ring, and each of the second electrode plates is disposed with a second pattern formed by a plurality of perforated holes and at the edge of each of the second electrode plates is disposed with an O-ring; a lock-fastening device, disposed on the top end and bottom end of the electrode plate stack structure for lock-fastening the electrode plate stack structure; wherein a topmost electrode plate and a bottommost electrode plate of the electrode plate stack structure are electrically connected to an electrode of first polarity, and a middle electrode plate of the stack structure is electrically connected to an electrode of second polarity, the first polarity and the second polarity being opposite polarities.

### BRIEF DESCRIPTION OF THE DRAWINGS

The present invention is best understood by reference to the embodiments described in the subsequent sections accompanied with the following drawings.

FIG. 1A is a view of arrangement of perforated holes on electrode plate of FTC of the present invention;

FIG. 1B is a view of arrangement of perforated holes on another electrode plate of FTC of the present invention;

FIG. 1C is a view of pattern of perforated holes on electrode plates as shown in FIG. 1A and FIG. 1B stacked on one another;

FIG. 1D is a view of electrode plate disposed with an O-ring;

FIG. 2 is a view of an electrode stack structure of FTC of the present invention;

FIG. 3 is a view of FTC module of the present invention;

FIG. 4 shows the curve line indicating changes in TDS quantity and the TDS removal rate of seawater after undergoing desalination operation processed by FTC module;

FIG. 5 shows the curve line indicating changes in TDS quantity and the TDS removal rate of tap water after undergoing softening operation processed by FTC module;

FIG. 6 is a view of an automated CDI water treatment system.

### DETAILED DESCRIPTION OF THE INVENTION AND BEST MODES

The preferred embodiments of the flow through capacitor (FTC) using hybrid configuration of monopolar and bipolar electrodes of the present invention are presented as follows.

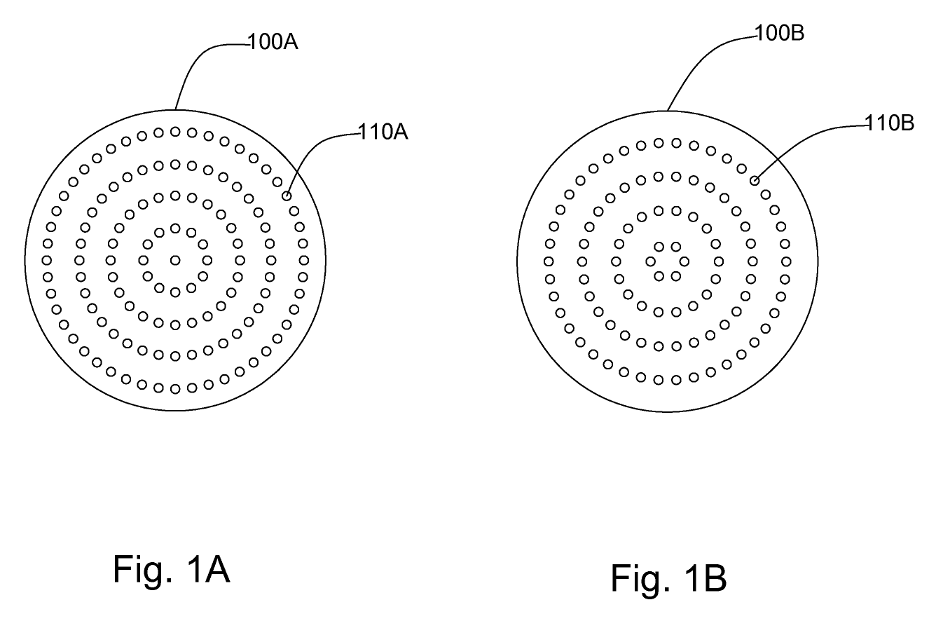

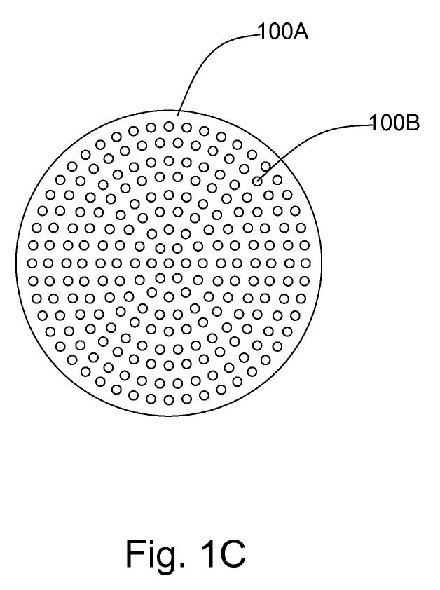

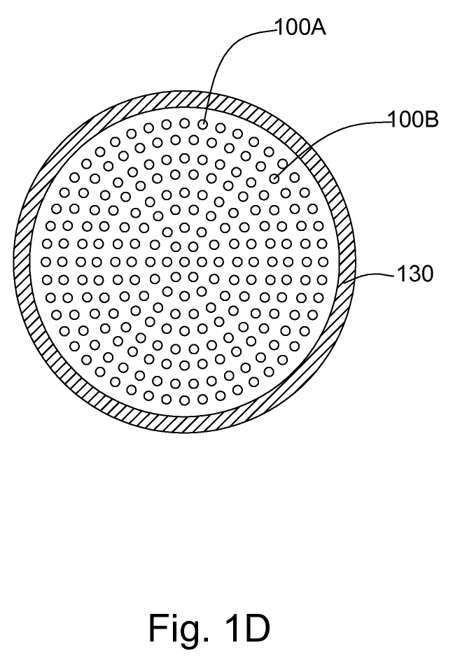

Referring to FIG. 1A, in which an electrode plate 100A formed by a titanium (Ti) plate coated with a layer of activated carbon as ion adsorption medium is shown, and the perforated holes 110A on the electrode plate 100A are arranged in geometric pattern, and more particularly, in the pattern of concentric rings. In the embodiment of the present invention, regardless of the size of electrode plate 100A, the invention has identified that the total bored area should be within 5 to 20%, or preferably 7 to 15%, of the total geometric area of electrode plate 100A. Under the prerequisite, the perforated holes can be any form arranged in any format, and FIG. 1A represents a preferred embodiment of the invention. The diameter of the holes, the number of holes, as well as the number and spacing of rings are dependent on the targets of throughput and product purity. Using a mathematical modeling, the pattern of openings on an electrode may be determined prior to the physical formation of holes for each application. In addition, FIG. 1B shows another electrode plate 100B formed by Ti substrate coated with layer of activated carbon and another preferred embodiment of ring pattern in which the plurality of perforated holes 110B on the electrode plate are arranged.

What is to be emphasized beforehand is that, the two patterns in which perforated holes on electrode plates 100A/100B as shown in FIGS. 1A/1B are arranged are two basic characteristics in the composition of FTC module of the present invention. In FTC module of the present invention, electrode plates 100A/100B as shown in FIGS. 1A/1B are stacked alternately. Although the locations of perforated holes on electrode plates 100A/100B as shown in FIGS. 1A/1B are different, yet in the stack structure formed by two electrode plates 100A/100B placed face to face, the surface area that cannot be used by capacitor will be two times of surface area of each electrode hole. The reason is that only in the space between two parallel facing electrodes with solid surface, there is a capacitance that is the foundation for ion adsorption, or ion removal of CDI operation. Hence, the more openings 110A/110B are made on each electrode 100A/100B, the less capacity of FTC cells for water treatment will be. Thus in the embodiment of the present invention, surface area covered by perforated holes on one electrode plate is preferred to be between 7% to 15% of surface area of the electrode.

Then, referring to FIG. 1C, in which a plurality of electrode plates 100A/100B as shown in FIGS. 1A and 1B are stacked into a FTC module, and the perforated holes can thus form the pattern of a group of concentric rings at intervals of same length, as shown in FIG. 1C. What is to be made clear here is that, FIG. 1C is actually a top view of composite arrangement of perforated holes after electrode plates 100A/100B are stacked, the primary objective of which is to demonstrate rings of perforated holes alternately arranged on adjacent electrodes. Since the perforated holes are arranged with a set distance between one perforated hole and another, liquids to undergo CDI treatment have to flow through the alternately arranged perforated holes in a continuous S-shape, zigzagged path to finally exit the FTC stack. By going in this zigzagged path, liquids to be treated can thus evenly mix and distribute in FTC cells. In addition, as the liquid can flow in any direction, electrodes can also be effectively wetted with such design. An appropriate spacing should be provided between any two adjacent rows of perforated holes, because the spacing will determine the flow distance of liquid and further influence the flow rate, the retention time, and the ease of flush during regeneration operation of FTC cells.

Furthermore, at the rim of each electrode plate 100A/100B as shown in FIGS. 1A/1B is disposed with an O-ring 130, as shown in FIG. 1D, the objective of which is to seal the edges of electrode plates when the electrode plates are stacked to form FTC modules. The material of O-ring 130 can be selected from rubber such as EPDM (ethylene propylene diene monomer), silicone, urethane, or PP, the thickness is from 0.6 to 1 mm, and the outer diameter of ring is longer than the diameter of electrode plate 100A/100B as shown in FIGS. 1A/1B while the inner diameter of ring is shorter than the diameter of electrode plate 100A/100B as shown in FIGS. 1A/1B with the difference between inner diameter and outer diameter being width of the O-ring 130. When liquids of any chemical properties are to undergo treatment of FTC module of the present invention, Ti substrate with thickness of 0.3 mm or above can be used as electrode plate (current collector) of FTC. However, when liquids with low chloride contents are to undergo treatment of FTC module, stainless steel of Grade 316, 314, or 304 can also be selected to be electrode plate of FTC to reduce capital cost of CDI system.

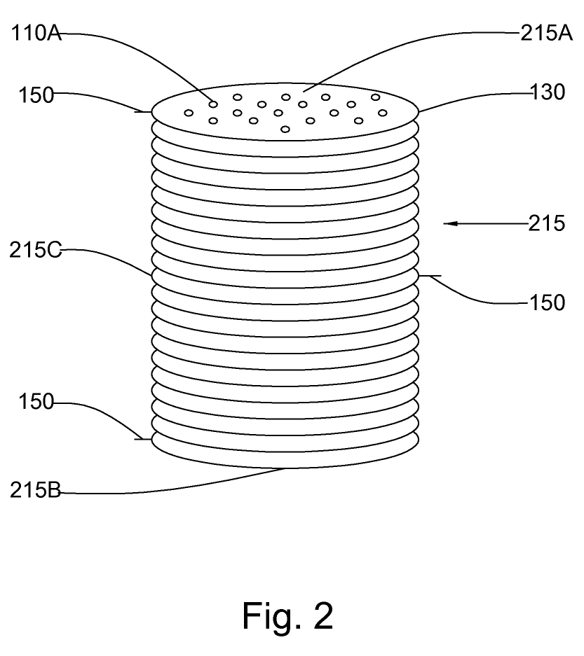

Then, referring to FIG. 2, a plurality of electrode plates 100A/100B as shown in FIGS. 1A/1B are vertically stacked to form an electrode plate stack structure 215. As shown in FIG. 2, the electrode plate stack structure 215 is formed by stacking 21 electrode plates 100A/100B as shown in FIGS. 1A/1B, wherein the 1^{st} top electrode 215A and the bottom 21^{st} electrode 215B of electrode plate stack structure 215 are selected as positive electrodes and the 11^{th} middle electrode 215C is selected as negative electrode, or the 1^{st} and the 21^{st} electrodes are selected as negative electrodes and the 11^{th} as positive electrode. Each of the aforementioned selected electrodes is disposed with a physical means 150, such as a tab on the edge of electrode for connecting each electrode to two poles of outer potential source.

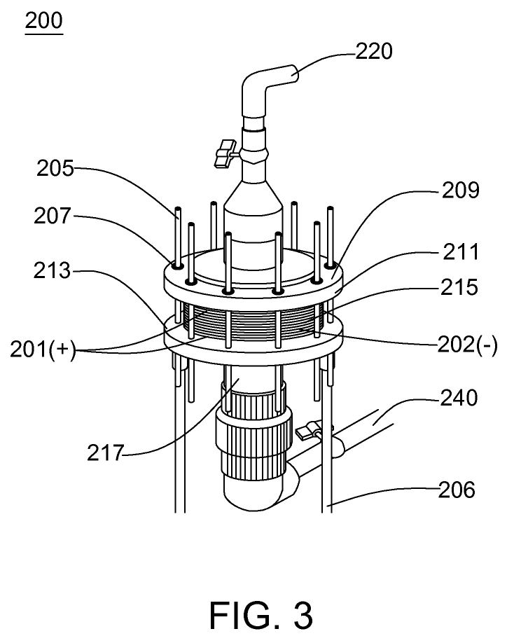

Then, referring to FIG. 3, which is a view of FTC of the present invention. As shown in FIG. 3, the top electrode 215A and the bottom electrode 215B in the electrode plate stack structure 215 of FTC module 200 are connected to positive electrode of DC potential source, and the middle electrode 215C is connected to negative electrode of DC potential source. Thus, these three electrodes are turned into monopolar electrodes (respectively indicated by a positive sign 201 and a negative sign 202), and the FTC module 200 thus has two subgroups with electrodes of the same number stacked. Two ends of each subgroup are disposed with a monopolar electrode to form a pair of positive and negative electrodes, between which are alternately disposed with nine other electrode plates 100A/100B with perforated holes arranged in pattern as shown in FIG. 1A and FIG. 1B (which can also be called intervening electrode plates). The intermediate electrode plates 100A/100B are not disposed with physical means 150 that can be connected to DC potential source, but the potential applied on the top end electrode 215A and the bottom end electrode 215B and a conductive liquid (containing ions) flowing through these electrodes will induce positive polarity on one side of each intermediate electrode plate and negative polarity on the other side. Consequently, the intervening electrode plates 100A/100B in the present invention actually function as bipolar connectors that are able to join 11 electrodes (including 2 monopolar electrodes and 9 bipolar electrodes) in series connection.

In regard to electrical connection, the FTC module 200 is composed of two subgroups including 11 electrodes in series connection, and these two subgroups are joined in parallel by sharing the middle monopolar electrode 215C. Therefore, the FTC module 200 disclosed in the present invention actually includes two subgroups in series connection, and the two sub-groups can further form parallel connection; a hybrid polar FTC module 200 with both series connection and parallel connection can thus be formed. Moreover, the FTC module 200 can also be composed of electrodes of number different from that above. Similarly, the number of monopolar electrode in FTC module 200 can also be more than three as described above, and the electrode array of FTC subgroup with series connection and parallel connection combined can be selectively arranged as longer or shorter.

As known in physics, the more electrodes are in a series connection, the higher working voltage is needed, but the operating current needed is lower. Contrarily, the more electrodes are in a parallel connection, the higher operation current is needed, but the working voltage needed is lower. Therefore for parallel connection, electrodes are all monopolar electrodes and each electrode needs to be connected to the potential source. Therefore, the amount of connecting points becomes larger, more materials are consumed, and thus the overall cost and complexity of CDI system is also increased. If the FTC module has hybrid polarity with both monopolar electrodes and bipolar electrodes, balance among working voltage, operation current, capital cost, and surface area occupied will be achieved more easily in the design of CDI system.

Then referring still to FIG. 3, the FTC module 200 in which does not need an enclosing case, and screw threads 205 and screw nuts 207 are used to compress the top metal ring 209 and the bottom metal ring 217 during fabrication for fixedly press-fitting 21 electrodes as shown in FIG. 1A and FIG. 1B, 21 O-rings, and 21 spacers between a top thick PP board 211 and a bottom thick PP board 213, wherein each electrode is disposed with an O-ring and a spacer (spacer is not shown in FIG. 2). In addition, a water inlet 220, a water outlet 240, and their respective piping are respectively attached to a top end and a bottom end of FTC module 200. After the fabrication of FTC module 200 is completed, examination for water leakage and electrical short needs to be made. Moreover, three steel supporting legs 260 are attached to the bottom end of FTC module 200 so that the device is self sustainable for operation at the desired points. What is to be emphasized is that, a spacer can be selectively disposed on each electrode and adjacent to the O-ring in the present embodiment. The spacer can be in the form of a mesh, net, screen, sieve, or web, the material of which is plastics such as nylon, polypropylene (PP), or urethane, and the thickness of which is about 0.5-0.8 mm. The function of spacer is to prevent from electrical shorts and form flow channels in which treated liquids flow through FTC module 200.

In another preferred embodiment of the present invention, a plurality of FTC module units (not including water inlet 220, water outlet 240, and steel supports 260 shown in FIG. 3) are integrated in an enclosing case formed by PP or other plastics tubing materials to form a compact FTC tube with all functions (not shown in the Figure). Obviously, when the FTC tube is disposed with three FTC module units, the handling capacity of FTC tube will be three times of the handling capacity of a single FTC unit. Therefore, with dimension and weight in reasonable range, a FTC tube can be formed by FTC of different numbers. Moreover, FTC tubes of certain required number can also be arranged like conventional configuration of RO membrane tubes into a plurality of groups of arrays in series connection and in parallel connection based on the capacity of FTC tube and total target yield to form a turn-key CDI treatment system that satisfies all requirements.

In the aforementioned FTC tube composed of three FTC module units, the FTC module units are connected with one another by plug-in fittings made of PP or other plastics, and each FTC module unit has electrode connected as shown in FIG. 3; therefore, the liquids to be treated can directly flow sequentially through the three FTC module units. Obviously, the liquids flow continuously through the FTC module units in the FTC tube, yet the operation voltage applied to the three FTC module units for the use of desalination operation is in parallel connection. Therefore, in a FTC tube for deionization, only one value of working voltage is to be supplied to three or more FTC module units. When the seawater desalination operation is performed, similar method of providing working voltage is also applicable for large- or small-scaled CDI system composing a plurality of FTC tubes in series connection. What is to be re-emphasized is that, regardless whether FTC tube used in the operation of CDI system is composed of one FTC module 200 or a plurality of branching FTC module units, only a single value of working voltage is needed for operation in the stage of desalination. Moreover, if the FTC module 200 or FTC tube is charged through parallel connection, the overall working voltage needed by a CDI system can be reduced.

In the stage of desalination of CDI treatment operation, the FTC module 200 or FTC tube will eventually be saturated from the adsorption of ions, and thus regeneration of FTC module 200 needs to be processed. The most economical way for regenerating FTC module 200 is to let saturated FTC module 200 discharge to a power reservoir, such as a supercapacitor (S/C), as described in the U.S. Pat. No. 6,580,598, U.S. Pat. No. 6,661,643, and U.S. Pat. No. 6,795,298. Obviously, CDI operation is a series of charging-discharging cycles of FTC module 200, and these cycles are actually a potential swing of FTC module 200 between charging and discharging. In other words, in the stage of desalination, a DC potential source is used for charging FTC module 200, and afterwards, FTC module 200 is controlled by the control device to discharge to complete the regeneration of FTC module 200; obviously, in the process of discharging, DC power source is in off status and does not supply power to FTC module 200.

According to the above description, in the present invention at lease 30% of electricity invested for desalination operation can be retrieved from the regeneration operation. For example, if CDI system of the present invention is used to desalinate 1 m³ of 350,000 ppm seawater into 1 m³ of 250 ppm freshwater, the electricity to be consumed is approximately 1 kWh. Therefore, the amount of collectible energy is significant in a CDI desalination system with capacity of 10,000 m³/day (CMD) or even higher capacities. S/C is possibly the most efficient energy-storage device for the energy recovery at the regeneration of CDI treatment. The reason is that S/C has a much lower resistance, also known as equivalent series resistance (ESR), the value of which is far smaller than that of FTC module 200. This means, when the two devices are connected in parallel, a hungry or an empty S/C will be charged immediately by the saturated FTC module 200. The charging rate is such a fast speed that more than 90% of the residual energy in the saturated FTC module 200 is transferred to S/C in seconds. Afterwards, the energy left-behind becomes insignificant as reflected by the minute voltage of the FTC module 200. Since the voltage of the FTC module 200 is a good indication of the amount of ions adsorbed on the electrodes, a small voltage of FTC module 200 means that most of the FTC electrode areas have been cleaned in the process of discharging to S/C. As a result, the regeneration of the FTC module 200 can be completed in seconds rather than hours as seen in the prior arts. Concurrent with the discharge of saturated FTC module 200 to S/C, a rinse liquid is passed through the FTC module 200 once to quickly reset the FTC module 200 for the next run of CDI treatment. Moreover, when all of the saturated FTC modules 200 are discharged in series to S/C, the regeneration of the FTC modules 200 can be further expedited.

Another reason for supercapacitor (S/C) to become the best device for retrieving energy from the saturated FTC module 200 is that the electricity is extracted and stored directly into S/C without using other accessory or energy conversion. This means that no mechanical movement or chemical reaction is needed in the energy recovery when using S/C, and thus S/C has a long duration and the recovery system is simple and cost effective. Other methods demand one kind or other form of energy conversion, for example, a LC circuit containing an inductor (L) and a capacitor (C) stores energy via noisy electromagnetic oscillations, a flywheel extracts energy using motor and generator, and RO pumps rely on pressure difference for energy recovery; unfortunately, every energy conversion is always accompanied with energy loss.

In addition, the energy stored in S/C can also be withdrawn quickly and directly from the device for other uses in the present embodiment. There is another approach to recycle the residual energy on the saturated FTC cells proclaimed in PCT/US2001/016406. Through an electrical apparatus, the residual energy is transferred from the saturated FTC modules to other FTC modules that just need power for desalination. Because the residual energy on the saturated FTC cells is often inconsistent and insufficient to meet the energy needs for desalination, the latter process will be restrained by the unreliable power provision. As a matter of fact, S/C can offer two important functions to the CDI treatment. In addition to the energy reclamation at the regeneration stage of CDI treatment, S/C is also the best device to supply the high power needs, particularly extremely high operation currents, for large-scale industrial desalinations.

For instance, as hundreds to thousands CMD of water is used in the industries for various productions, the required electrodes areas of FTC modules must be measured in m². If the current density for desalination is 20 mA/cm², then, 1 m² electrode area requires an operation current of 200 A. An S/C with rated voltage and capacitance of 15 V×40 F and an internal resistance (ESR) of 10 mΩ or lower can deliver a peak current of 200 A for 2 seconds. With a constant charging current of 20 A provided by a power supply, two 15 V×40 F S/C modules can continuously and steadily deliver the 200 A peak current. In the foregoing power provision, each S/C module is allowed to discharge only its effective energy, namely, each S/C is engaging a shallow discharge. After one S/C module has released its energy quotas, the other S/C module will immediately assume the role of discharge, and concurrently, the slightly discharged S/C will undergo recharging. Since the depth of discharge (DOD) of S/C is shallow and the charging rate of the power supply is high, the S/C modules can be replenished quickly. In the next cycle, the two S/C modules exchange their positions of charging and discharging, and the process will go on and on until the power need is fulfilled. The technique of switching two S/C sets reciprocally between charging and discharging for continuous delivery of a consistent peak power is called CD swing. Also, the CD swing has a high efficiency of energy utilization since the S/C sets are regulated to dispense only their effective energy.

Even though the FTC cells may not fully utilize the current capacity provided by a power supply during the stage of desalination, an oversized current setting is better than the undersized in terms of enhancement of the ion-removal rate of CDI treatment. Similar to the initial charging of electrochemical capacitors that start very fast but become slow when approaching the fully charged state, the FTC cells also quickly adsorb ions at the initiation of charging, which is followed by a gradual decay of the charging current signifying the level-off of ion adsorption. Therefore, the current measured at the charging of FTC cells is an indication of the degree of ion adsorption. While the CDI treatment is operated under constant voltage mode, the operation current is actually regulated by the progressive capturing of ions on the FTC electrodes. It is the operation current as actually measured, rather than the current setting on the power supply, that determines the actual power consumption of CDI treatment. In order to expedite the initial stage of ion removal, a provision of high current should become accessible to the FTC modules. Nevertheless, it is highly uneconomical to employ a giant-size power supply capable of providing hundreds of ampere for large-scale water treatments. Henceforth, the present invention discloses an automated CDI water treatment system, in which small-scale power system is utilized and super-capacitor and method of implementing super-capacitor (i.e. CD swing) are applied to cost-effectively and energy-efficiently manage the power demands of CDI treatment operation.

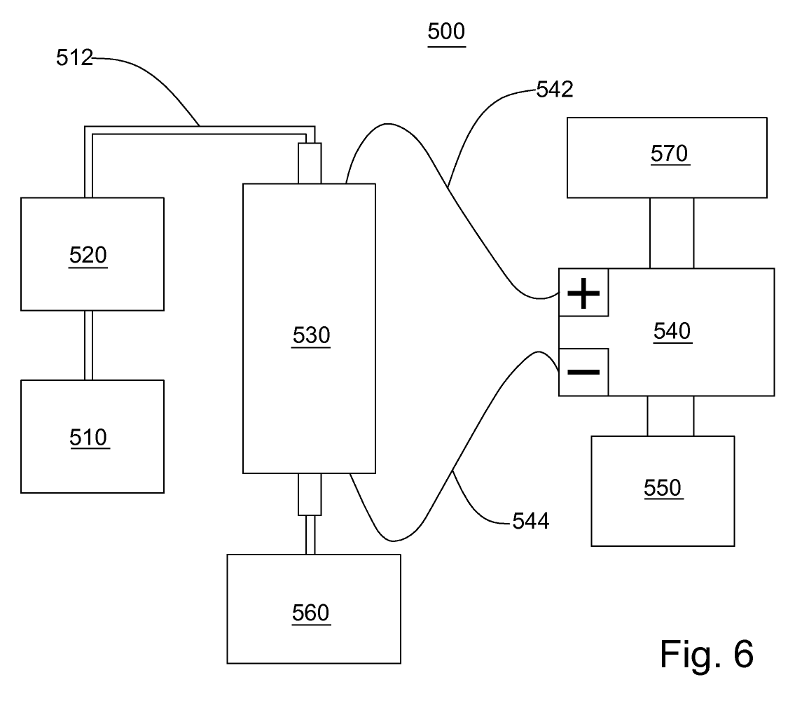

Referring to FIG. 6, which shows an automated CDI water treatment system of the present invention comprising hybrid polar FTC. To facilitate the description, treatment of seawater desalination will be described in the present embodiment. As shown in FIG. 5, a pump 520 draws seawater from a water reservoir 510, and the seawater is then delivered to hybrid polar FTC tube 530 via conduit 512. What is to be emphasized here is that, the FTC tube 530 in the present embodiment is composed of a plurality of FTC modules 200. When seawater flows through each FTC tube 530, it undergoes one run of desalination (i.e. deionization) treatment and another. The treated water is then collected in another water reservoir 560 through conduit 512. Moreover, an online sensor (not shown in FIG. 6) can be further installed to determine whether the water collected reaches the target value of TDS quantity or should undergo further deionization treatment.

Referring still to FIG. 6, the electrode stack of FTC tube 530 is sealed in a enclosing case, and each FTC tube 530 is respectively disposed with at least 2 power supply leads 542/544 for connecting to a power supply control module 540 to process charging and discharging. Moreover, the power supply apparatus 550 can provide the power supply control module 540 with a voltage (40V for example) for the FTC tube 530 to process charging in parallel connection. After each FTC tube 530 receives charging voltage provided by the power supply apparatus 550 via the power supply control module 540, ions contained in seawater can be removed by each FTC module 200 in the FTC tube 530. Therefore, when seawater flows downward through stack electrode of each FTC module 200, the TDS quantity in seawater will also gradually decrease. Furthermore, it should be emphasized that, the number of FTC tube 530 or the number of FTC module 200 to be used fully depends on the time for completion as needed by the user.

When electrodes in FTC module 200 are saturated with adsorption of ions, the regeneration operation of electrodes needs to be performed to regenerate the surface of electrodes. The method of regenerating surface of electrodes is as follows, the operation of pump 520 is first terminated to stop the conduit 512 from delivering seawater to FTC tube 530; meantime, the provision of charging voltage to FTC tube 530 by power supply apparatus 550 is terminated. Then, the remaining power in electrodes of FTC tube 530 is then discharged to a super-capacitor pack 570 that has not stored any power, a supercapacitor pack having rated operating voltage of 15V and nominal capacitance of 40 F for example, and the super-capacitor pack 570 can thus be charged, wherein the supercapacitor pack 570 is connected to power supply control module 540 through electric cables. Moreover, in order to expedite the release of remaining power, the FTC tube 530 can discharge in series connection, and the remaining power can also be a signal of amount of residual ions on electrodes of FTC tube 530. Furthermore, in order to correspond with high voltage and high capacitance needed by charging and discharging of FTC tube 530, the supercapacitor pack 570 can be formed by series connection, parallel connection, or combinatory connections of the two, which is not limited in the present invention. In addition, all CDI operations including “deionization of water” and “regeneration of FTC module” are conducted through PLC (programmable logic control).

To re-explicate, the CDI treatment relies on an electrostatic field built within the FTC modules to desalinate brackish water and seawater. Besides ion-adsorbing material, the FTC structure and applied voltage, the current provision is a critical parameter for enhancing the field strength as well. In the following two examples, the deionization of waters by FTC modules of the invention using other current settings than the listed values can not yield products of the same quality.

### EXAMPLE 1

A FTC unit is made by stacking 21 pieces of activated carbon-coated Ti plates, and the stack is placed in a plastic case to form an independent FTC module 200. Each plate has a diameter of 10 cm with perforated holes in a pattern as shown either in FIG. 1A or in FIG. 1B, and thus the active area of one side of an electrode is about 66.7 cm². Since the FTC module 200 has 20 electrodes, the total effective electrode area of one FTC unit is 1,334 cm². Five of the foregoing FTC modules are connected in series for water to flow continuously through the tandem array, but each FTC module 200 will receive a charging current independently through their two electrical leads respectively welded to the top and bottom electrodes of each FTC stack. Thus, each FTC unit is a series array of 19 pieces of bipolar electrodes sandwiched by a pair of positive and negative electrodes. For charging the five FTC units in parallel, the 10 electrical leads are first divided into two groups, wherein each group contains five leads, and then, one group is linked to the positive pole of an outer power supply and the other group to the negative pole.

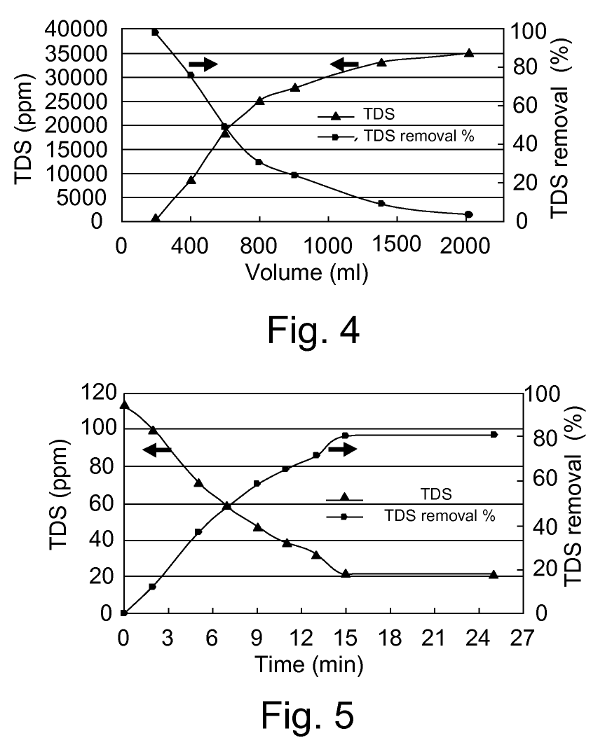

After a simple filtration through filter paper to remove sizable particles, a 2-liter seawater with TDS (total dissolved solids) of 36,600 ppm is passed at flow rate of 600 ml/min through the tandem array of five FTC units that are charged by a power of 40 V×40 A from a power system containing a DC power supply and two 15 V×40 F supercapacitor modules. FIG. 4 shows the one-pass treatment results in two curves, one of which is the TDS measurements of seven effluents collected every 200 ml for the first five collections and every 500 ml for the last two collections. The other curve is the ion removal rate calculated for each collection. Table 1 lists the measurements of TDS for seven effluents, as well as the ion removal rate of each effluent.

TABLE 1
Desalination of 36,600 ppm Seawater in One Pass
Through Five 10 cm Diameter FTC Cells Charged
in Parallel by a Power Setting of 40 V × 40 A

| Effluent # | Effluent Vol. (ml) | TDS (ppm) | Ion Removal Rate (%) |
|---|---|---|---|
| 1 | 200 | 785 | 97.86 |
| 2 | 200 | 8,890 | 75.71 |
| 3 | 200 | 18,600 | 49.18 |
| 4 | 200 | 25,200 | 31.15 |
| 5 | 200 | 27,900 | 23.77 |
| 6 | 500 | 33,200 | 9.29 |
| 7 | 500 | 35,200 | 3.83 |

The third column of Table 1 is the TDS measurements of seven effluents, and the fourth column is calculated by subtracting the TDS of each effluent from the original seawater, and then, the TDS difference is divided by the TDS of raw seawater to attain the ion removal rate for that particular effluent. As seen in Table 1 and FIG. 4, the raw seawater is quickly desalinated to 785 ppm, a 97.86% ion removal rate, in the first 200 ml of effluent. With ions accumulated on the FTC units, TDS of the second effluent ascends to ten times more than that of the first effluent and the corresponding ion removal rate drops drastically. This indicates the fast charging of FTC as well as the rapid rate of ion adsorption. Also, the quick saturation of the FTC electrodes is a reflection of small effective areas provided for desalination. Based on the unitary area, the five FTC units collectively offer an overall effective area of 6,670 cm² for ion adsorption. During the desalination, the DC voltage applied to the FTC modules remains at 40V, thus, each cell is operated 2 V DC. Though the current is set at 40 A, the operation current is only registered as 8.5 A. Therefore, the power consumption for the desalination of Table 1 is 340 W. Other current settings, for example, 20 A and 30 A, cannot produce as fast deionization and clean water product as Table 1 (data are not shown). An instant current hike greater than 30 A may be needed at the initiation of charging (desalting) the five FTC modules to desalinate the seawater of the present embodiment; thus, the current setting should be higher than 30 A to sustain the desalination process. Nevertheless, Table 1 has clearly demonstrated the viable capability of the invention on desalinating a seawater without dilution, chemical pre-treatment or micro-filtration. On the other hand, the capacity of desalination using the techniques of the invention can be easily improved by allowing the seawater to pass the FTC cells one more time, or by guiding the seawater to flow through more FTC units or larger FTC units.

### EXAMPLE 2

A stand alone FTC module is made as that shown in FIG. 2, wherein 21 pieces of electrodes are stacked vertically. Three electrodes, namely, the first, the eleventh and the twenty-first, are selected as the monopolar electrodes by connecting two electrical leads that are attached to the end electrodes to the positive pole of a power supply, and the lead of middle electrode to the negative pole. Between each pair of positive and negative electrodes, there are nine bipolar electrodes to connect eleven electrodes in series. All electrodes are made of activated carbon-coated stainless steel plates having a diameter of 10 cm with perforated holes in a pattern as shown in either FIG. 1A or FIG. 1B. Each electrode has an effective area of 267 cm² on one side, thus, the total effective areas of the FTC module containing 20 cells is 5,340 cm². With a power setting of 30 V×10 A from a power system containing a DC power supply and two 15 V×40 F S/C sets applied to the FTC module, a 10-liter tap water with TDS of 114 ppm is circulated through the capacitor at a low rate of 2.4 l/min for hard ions to be removed in order for tap water to be turned into soft water. The TDS of the treated water is measured at several selected time intervals, and the results are tabulated in Table 2, and plotted in FIG. 5.

TABLE 2
Softening of Tap Water with TDS of 114 ppm by Circulating
Through a 20-cm Diameter FTC Module Using Hybrid
Polar Electrodes Charged by 30 V × 10 A

| Time of Measurement (min) | TDS (ppm) | Ion Removal Rate (%) |
|---|---|---|
| 2 | 100.1 | 12.19 |
| 5 | 71.6 | 37.19 |
| 7 | 59.2 | 48.07 |
| 9 | 47.2 | 58.60 |
| 11 | 39.1 | 65.70 |
| 13 | 32.2 | 71.75 |
| 15 | 22.1 | 80.61 |
| 25 | 21.3 | 81.32 |

Comparing to the seawater of Example 1, the tap water contains much fewer ions. The desalination of water with low quantity of ion contained is characterized by the slow start of ion adsorption (or ion removal), low operation current, 2.6 A, measured at deionization and no clear saturation of FTC cells observed during the duration of experiment. Actually, the TDS measurement of Table 2 is a dynamic-mode determination, that is, the measured TDS of the circulated water changes with time. As more treatments are performed, that is, longer circulation time, the water will gradually become cleaner and cleaner, and the accompanying ion removal rate is also improved. The third column of Table 2 is the ion removal rate of a TDS measurement at a selected time relative to the initial TDS. If 80 ppm is the purity standard for potable soft water, the 10-liter tap water of the present test only needs treatment for 5 minutes, which is equivalent to one single pass of all tap water through the charged FTC module.

### CONCLUSION

There are five major parameters to warrant the economical viability of the CDI technique for large-scale water treatments: ion-adsorbing material, structure of FTC cells, applied voltage, current provision and CDI operation protocol, particularly, the energy management. It is difficult to weigh one parameter over the other. However, the two stages of CDI operation, namely, deionization (desalination) and regeneration, should be conducted with the least consumption of time, energy and other resources, such as, clean rinse water. Essentially the CDI treatment is a charging and discharging of capacitor, therefore, both the absorption and desorption of ions can be controlled by the power source. Through the operation of charging and discharging, when application of potential to FTC module 200 is off, ions will no longer adhere to the electrodes of FTC. And rinse water of almost any grade can be used for flushing the desorbed ions to regenerate 80% of the electrode area of FTC cells or higher.

Although preferred embodiments of the present invention have been disclosed as described above, they are not to limit the present invention, and it will be apparent to those skilled in the art that similar arrangements and various modifications of the described embodiments may be made without departing from the spirit and scope of the present invention. Accordingly, the scope of the invention will be defined by the attached claims.

What is claimed is:

1. A FTC module, comprising:
an electrode plate stack structure, said electrode plate stack structure being composed of a plurality of first electrode plates and a plurality of second electrode plates disposed alternately at intervals, wherein each of said first electrode plates is disposed with a first pattern formed by a plurality of perforated holes and at edge of each of said first electrode plates is disposed with an O-ring, and each of said second electrode plates is disposed with a second pattern formed by a plurality of perforated holes and at edge of each of said second electrode plates is disposed with an O-ring; and
a lock-fastening device, disposed on top end and bottom end of said electrode plate stack structure for lock-fastening said electrode plate stack structure;
wherein a topmost electrode plate and a bottommost electrode plate of said electrode plate stack structure are connected to an electrode of first polarity, and a middle electrode plate of said stack structure is connected to an electrode of second polarity, said first polarity and said second polarity being opposite polarities.

2. The FTC module according to claim 1, wherein a spacer is further disposed at edge of each of said O-ring of said electrode plate stack structure.

3. The FTC module according to claim 1, wherein said first pattern and said second pattern are the same and a shift is between said first pattern and said second pattern.

4. The FTC module according to claim 1, wherein material of each of said electrode plate is Ti substrate coated with layer of activated carbon.

5. The FTC module according to claim 1, wherein material of each of said electrode plate is stainless steel plate coated with layer of activated carbon.

6. The FTC module according to claim 1, wherein opening on each of said electrode plate occupies 7% to 15% of total surface area of said monopolar electrode.

7. The FTC module according to claim 1, wherein each of said spacer is in form of a mesh, net, screen, sieve, or web.

8. The FTC module according to claim 3, wherein said first pattern and said second pattern form a concentric circle.

9. The FTC module according to claim 1, further comprising a supporting mechanism connected with said lock-fastening device.

10. The FTC module according to claim 1, wherein said first polarity is electropositive.

11. A water treatment apparatus, composed of a FTC module and a DC potential source, top end of said FTC module being connected to a water inlet device and bottom end of said FTC module being connected to a water outlet device, wherein characteristics of said FTC module comprising:
an electrode plate stack structure, said electrode plate stack structure being composed of a plurality of first electrode plates and a plurality of second electrode plates disposed alternately at intervals, wherein each of said first electrode plates is disposed with a first pattern formed by a plurality of perforated holes and at edge of each of said first electrode plates is disposed with an O-ring, and each of said second electrode plates is disposed with a second pattern formed by a plurality of perforated holes and at edge of each of said second electrode plates is disposed with an O-ring;
a lock-fastening device, disposed on top end and bottom end of said electrode plate stack structure for lock-fastening said electrode plate stack structure;
wherein a topmost electrode plate and a bottommost electrode plate of said electrode plate stack structure are connected to an electrode of first polarity, and a middle electrode plate of said stack structure is connected to an electrode of second polarity, said first polarity and said second polarity being opposite polarities.

12. The water treatment apparatus according to claim 11, wherein a spacer is further disposed at edge of each of said O-ring of said electrode plate stack structure.

13. The water treatment apparatus according to claim 11, wherein said first pattern and said second pattern are the same and a shift is between said first pattern and said second pattern.

14. The water treatment apparatus according to claim 11, wherein each of said spacer is in form of a mesh, net, screen, sieve, or web.

15. The water treatment apparatus according to claim 13, wherein said first pattern and said second pattern form a concentric circle.

16. The water treatment apparatus according to claim 11, wherein material of each of said electrode plate is Ti substrate coated with layer of activated carbon.

17. The water treatment apparatus according to claim 11, wherein material of each of said electrode plate is stainless steel plate coated with layer of activated carbon.

18. The water treatment apparatus according to claim 11, wherein opening on each of said electrode plate occupies 7% to 15% of total surface area of said monopolar electrode.

19. The water treatment apparatus according to claim 11, wherein said first polarity is electropositive.

20. The water treatment apparatus according to claim 11, wherein waters treated by said water treatment apparatus comprise: industrial wastewater and seawater.

21. A water treatment apparatus, composed of a FTC module, a plurality of super-capacitor devices, a DC potential source, and a control device, wherein said FTC module and said plurality of super-capacitor devices form parallel connection, top end of said FTC module is connected to a water inlet device and bottom end of said FTC module is connected to a water outlet device, and said control device is connected to said plurality of super-capacitor devices for controlling at least two super-capacitor devices to perform CD swing, wherein characteristic of said water treatment apparatus lies in that said FTC module comprises:
an electrode plate stack structure, said electrode plate stack structure being composed of a plurality of first electrode plates and a plurality of second electrode plates disposed alternately at intervals, wherein each of said first electrode plates is disposed with a first pattern formed by a plurality of perforated holes and at edge of each of said first electrode plates is disposed with an O-ring, and each of said second electrode plates is disposed with a second pattern formed by a plurality of perforated holes and at edge of each of said second electrode plates is disposed with an O-ring;
a lock-fastening device, disposed on top end and bottom end of said electrode plate stack structure for lock-fastening said electrode plate stack structure;
wherein a topmost electrode plate and a bottommost electrode plate of said electrode plate stack structure are connected to an electrode of said DC potential source, and a middle electrode plate of said stack structure is connected to another electrode of said DC potential source.

22. The water treatment apparatus according to claim 21, wherein waters treated by said water treatment apparatus comprise: industrial wastewater and seawater.

23. A water treatment apparatus, composed of a plurality of FTC modules, a plurality of super-capacitor devices, a DC potential source, and a control device, said plurality of FTC modules being fixed in an insulation mask and forming parallel connection with said plurality of super-capacitor devices, top end of said mask being connected to a water inlet device and bottom end of said mask being connected to a water outlet device, and said control device being connected to said plurality of super-capacitor devices for controlling at least two super-capacitor devices to perform CD swing, wherein characteristic of said water treatment apparatus lies in that each of said FTC modules comprises:
an electrode plate stack structure, said electrode plate stack structure being composed of a plurality of first electrode plates and a plurality of second electrode plates disposed alternately at intervals, wherein each of said first electrode plates is disposed with a first pattern formed by a plurality of perforated holes and at edge of each of said first electrode plates is disposed with an O-ring, and each of said second electrode plates is disposed with a second pattern formed by a plurality of perforated holes and at edge of each of said second electrode plates is disposed with an O-ring;
a lock-fastening device, disposed on top end and bottom end of said electrode plate stack structure for lock-fastening said electrode plate stack structure;
wherein a topmost electrode plate and a bottommost electrode plate of said electrode plate stack structure are connected to an electrode of said DC potential source, and a middle electrode plate of said stack structure is connected to another electrode of said DC potential source.

24. The water treatment apparatus according to claim 23, wherein a spacer is further disposed at edge of each of said O-ring of said electrode plate stack structure.

25. The water treatment apparatus according to claim 23, wherein said first pattern and said second pattern are the same and a shift is between said first pattern and said second pattern.

26. The water treatment apparatus according to claim 23, wherein material of each of said electrode plate is Ti substrate coated with layer of activated carbon.

27. The water treatment apparatus according to claim 23, wherein material of each of said electrode plate is stainless steel plate coated with layer of activated carbon.

28. The water treatment apparatus according to claim 23, wherein opening on each of said electrode plate occupies 7% to 15% of total surface area of said monopolar electrode.

29. The water treatment apparatus according to claim 23, wherein each of said spacer is in form of a mesh, net, screen, sieve, or web.

30. The water treatment apparatus according to claim 23, wherein waters treated by said water treatment apparatus comprise: industrial wastewater and seawater.

31. A FTC module, comprising:
an electrode plate stack structure, said electrode plate stack structure being composed of a plurality of first electrode plates and a plurality of second electrode plates disposed alternately at intervals, wherein each of said first electrode plates is disposed with a first pattern formed by a plurality of perforated holes and at edge of each of said first electrode plates is disposed with an O-ring, and each of said second electrode plates is disposed with a second pattern formed by a plurality of perforated holes and at edge of each of said second electrode plates is disposed with an O-ring;
a lock-fastening device, disposed on top end and bottom end of said electrode plate stack structure for lock-fastening said electrode plate stack structure;
wherein said electrode plate stack structure can be divided into a plurality of electrode plate stack sub-structure, a topmost electrode plate and a bottommost electrode plate of each of said electrode plate stack sub-structure being connected to an electrode of first polarity, and a middle electrode plate of said electrode plate stack sub-structure being connected to an electrode of second polarity, said first polarity and said second polarity being opposite polarities.

32. The FTC module according to claim 31, wherein said first polarity is electropositive.

33. A water treatment apparatus, composed of a plurality of FTC tubes, a plurality of super-capacitor devices, a DC potential source, and a control device, said plurality of FTC tubes being fixed in an insulation mask and forming parallel connection with said plurality of super-capacitor devices, top end of said mask being connected to a water inlet device and bottom end of said mask being connected to a water outlet device, and said control device being connected to said plurality of super-capacitor devices for controlling at least two super-capacitor devices to perform CD swing, wherein each of said FTC tubes is composed of a plurality of FTC modules, characteristic of each of said FTC modules comprising:
an electrode plate stack structure, said electrode plate stack structure being composed of a plurality of first electrode plates and a plurality of second electrode plates disposed alternately at intervals, wherein each of said first electrode plates is disposed with a first pattern formed by a plurality of perforated holes and at edge of each of said first electrode plates is disposed with an O-ring, and each of said second electrode plates is disposed with a second pattern formed by a plurality of perforated holes and at edge of each of said second electrode plates is disposed with an O-ring;
a lock-fastening device, disposed on top end and bottom end of said electrode plate stack structure for lock-fastening said electrode plate stack structure;
wherein a topmost electrode plate and a bottommost electrode plate of said electrode plate stack structure are connected to an electrode of said DC potential source, and a middle electrode plate of said stack structure is connected to another electrode of said DC potential source.

34. The water treatment apparatus according to claim 33, wherein a spacer is further disposed at edge of each of said O-ring of said electrode plate stack structure.

35. The water treatment apparatus according to claim 33, wherein said first pattern and said second pattern are the same and a shift is between said first pattern and said second pattern.

36. The water treatment apparatus according to claim 33, wherein material of each of said electrode plate is Ti substrate coated with layer of activated carbon.

37. The water treatment apparatus according to claim 33, wherein material of each of said electrode plate is stainless steel plate coated with layer of activated carbon.

38. The water treatment apparatus according to claim 33, wherein opening on each of said electrode plate occupies 7% to 15% of total surface area of said monopolar electrode.

39. The water treatment apparatus according to claim 33, wherein each of said spacer is in form of a mesh, net, screen, sieve, or web.

40. The water treatment apparatus according to claim 33, wherein waters treated by said water treatment apparatus comprise: industrial wastewater and seawater.
